(19) United States
(12) Patent Application Publication
(10) Pub. No.: US 2026/0063818 A1
(43) Pub. Date: Mar. 5, 2026

(54) MAGNETIC FIELD IMAGE ACQUISITION APPARATUS AND METHOD BASED ON RESONANT STRUCTURE

(71) Applicant: ELECTRONICS AND TELECOMMUNICATIONS RESEARCH INSTITUTE, Daejeon (KR)

(72) Inventors: In-Kui CHO, Daejeon (KR); Jang-Yeol KIM, Daejeon (KR); Jung-Hoon OH, Daejeon (KR); Kye-Seok YOON, Sejong-si (KR); Hyun-Joon LEE, Daejeon (KR)

(73) Assignee: ELECTRONICS AND TELECOMMUNICATIONS RESEARCH INSTITUTE, Daejeon (KR)

(21) Appl. No.: 19/314,986

(22) Filed: Aug. 29, 2025

(30) Foreign Application Priority Data
Sep. 3, 2024 (KR) 10-2024-0118959
Aug. 22, 2025 (KR) 10-2025-0117324

(51) Int. Cl. G01V 3/10

(52) U.S. Cl. CPC G01V 3/104

(57) ABSTRACT

Disclosed herein are a magnetic field image acquisition apparatus and method based on a resonant structure. The magnetic field image acquisition apparatus based on a resonant structure includes a transmitting coil configured to generate a primary magnetic field, and a resonance coil excited by the primary magnetic field to form a secondary magnetic field, wherein the magnetic fields formed by the transmitting coil and the resonance coil are detected to generate a magnetic field image, and the transmitting coil and the resonance coil are designed to resonate at an identical operating frequency.

### CROSS REFERENCE TO RELATED APPLICATIONS

This application claims the benefit of Korean Patent Application Nos. 10-2024-0118959, filed Sep. 3, 2024 and 10-2025-0117324, filed Aug. 22, 2025, which are hereby incorporated by reference in their entireties into this application.

### BACKGROUND OF THE INVENTION

### 1. Technical Field

The following embodiments relate to an image acquisition technology for detecting the location, depth, and shape of underground buried objects, such as subsurface structures.

### 2. Description of the Related Art

Methods for obtaining information on the location or size of underground and subsurface facilities correspond to highly challenging technologies.

This is because the subsurface is mostly composed of soil or rock and contains moisture, making it a medium through which most means such as light, ultrasound, and electromagnetic waves can hardly penetrate or pass. A representative example thereof is that detecting landmines buried underground is not easy, and accurately determining the location thereof is also not a simple task.

In addition, in the case of a container box made of metal, a specific signal cannot pass through the container box, so a strong signal such as a X-ray signal is emitted, and a reflected signal is used to scan the inside of the container. Another example is installing a device around or in a sewer pipeline to detect an object, such as a magnet, and measuring the magnetic field, thereby determining the magnet's position and size; however, in this case as well, the degree of uncertainty in position and image acquisition remains very high.

As a conventional method for detecting very weak signals underground in this way, electric field-based Ground Penetrating Radar (GPR) has been widely used, and this method corresponds to technology for emitting electromagnetic waves and acquiring reflected wave images from geological layers. However, the method has an exploration depth varying depending on the moisture content of a medium, has limited resolution, and can determine only whether a metallic object is present.

In other words, the conventional method obtains information about penetration depth using a technique such as GPR and this technology is characterized by being based on electric fields. This method has limitations in detection range when encountering highly lossy dielectric materials, and has resolution that is fundamentally constrained.

A further method involves an intelligent subsurface line marker, which can store and update various types of subsurface information. However, when positions shift due to construction or disasters, discrepancies with the actual sewer pipeline location occur. A magnetic marker method can be used regardless of pipe material, but measurement errors occur depending on the installation direction of the marker, and it has the disadvantage of shallow probing depth.

In addition, a metal pipe detector is limitedly applied only to metal pipelines, and is disadvantageous in that it requires a wired connection

### SUMMARY OF THE INVENTION

An embodiment is intended to generate a signal based on a magnetic field rather than an electric field, thus making it more suitable for application to subsurface environments where dielectric loss is always present, and maximizing the depth at which subsurface images can be acquired.

In accordance with an aspect of the present disclosure, there is provided a magnetic field image acquisition apparatus based on a resonant structure, including a transmitting coil configured to generate a primary magnetic field, and a resonance coil excited by the primary magnetic field to form a secondary magnetic field, wherein the magnetic fields formed by the transmitting coil and the resonance coil are detected to generate a magnetic field image, and the transmitting coil and the resonance coil are designed to resonate at an identical operating frequency.

The magnetic field image acquisition apparatus may further include an excitation coil arranged in proximity to the transmitting coil to form a magnetic field for indirect feeding to the transmitting coil.

At least one of the transmitting coil, the resonance coil or the excitation coil, or a combination thereof may have a loop shape, and a ferrite core may be inserted thereinto.

The magnetic field image acquisition apparatus may further include a magnetic field receiver that is a loop-shaped sensor array configured to detect the magnetic fields.

The magnetic field image acquisition apparatus may further include a power regeneration unit attached to the magnetic field receiver and configured to store the magnetic field signal and use the magnetic field signal as an energy source.

The magnetic field image acquisition apparatus may further include a weak magnetic field signal detection unit implemented as an atom magnetometer that detects a weak magnetic field signal.

The magnetic field image acquisition apparatus may further include a magnetic field image signal processing unit configured to acquire the magnetic field image based on magnitudes and phases of magnetic field signals at respective points of the detected magnetic fields in a space.

The magnetic field image signal processing unit may distinguish the primary magnetic field from the secondary magnetic field.

In accordance with another aspect of the present disclosure, there is provided a magnetic field image acquisition method based on a resonant structure, including generating a primary magnetic field through a transmitting coil, generating a secondary magnetic field through a resonance coil excited by the primary magnetic field, and generating a magnetic field image by detecting the magnetic fields generated by the transmitting coil and the resonance coil, wherein the transmitting coil and the resonance coil are designed to resonate at an identical operating frequency.

Generating the primary magnetic field may include forming a magnetic field through an excitation coil arranged in proximity to the transmitting coil, and generating the primary magnetic field through the transmitting coil excited by the magnetic field formed by the excitation coil.

At least one of the transmitting coil, the resonance coil or the excitation coil, or a combination thereof may have a loop shape, and a ferrite core may be inserted thereinto.

Generating the magnetic field image may include detecting magnetic fields generated in a space, acquiring the magnetic field image based on magnitudes and phases of magnetic field signals at respective points of the detected magnetic fields in the space.

Detecting the magnetic fields may include detecting a weak magnetic field signal with high sensitivity through an atom magnetometer that detects a weak magnetic field signal.

In accordance with a further aspect of the present disclosure, there is provided a magnetic field image acquisition apparatus based on a resonant structure, including a transmitting coil configured to generate a primary magnetic field, a resonance coil excited by the primary magnetic field to form a secondary magnetic field, a magnetic field receiver that is a loop-shaped sensor array configured to detect the magnetic fields, and a magnetic field image signal processing unit configured to acquire a magnetic field image based on magnitudes and phases of magnetic field signals at respective points of the detected magnetic fields in a space, wherein the transmitting coil and the resonance coil are designed to resonate at an identical operating frequency.

The magnetic field image acquisition apparatus may further include an excitation coil arranged in proximity to the transmitting coil to form a magnetic field for indirect feeding to the transmitting coil.

At least one of the transmitting coil, the resonance coil or the excitation coil, or a combination thereof may have a loop shape, and a ferrite core may be inserted thereinto.

The magnetic field image acquisition apparatus may further include a power regeneration unit attached to the magnetic field receiver and configured to store the magnetic field signal and use the magnetic field signal as an energy source.

The magnetic field image acquisition apparatus may further include a weak magnetic field signal detection unit implemented as an atom magnetometer that detects a weak magnetic field signal.

The magnetic field image signal processing unit may distinguish the primary magnetic field from the secondary magnetic field.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an example of an eddy current secondarily generated in a metal plate;

FIG. 2 is a perspective view of a system for implementing magnetic field acquisition using a metal plate;

FIG. 3 is a plan view of a system for implementing magnetic field acquisition using a metal plate;

FIGS. 4 and 5 are diagrams illustrating examples of a magnetic field image acquired using a metal plate;

FIG. 6 is a perspective view of a system for implementing magnetic field acquisition using a resonance coil;

FIG. 7 is a plan view of a system for implementing magnetic field acquisition using a resonance coil;

FIGS. 8 and 9 are diagrams illustrating examples of a magnetic field image acquired using a resonance coil;

FIG. 10 is a schematic block configuration diagram of a magnetic field image acquisition apparatus based on a resonant structure according to an embodiment;

FIG. 11 is a diagram illustrating an example of the configuration of a magnetic field image acquisition apparatus based on a resonant structure according to an embodiment; and

FIG. 12 is a flowchart for explaining a magnetic field image acquisition method based on a resonant structure according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

The following embodiment relates to a scheme for generating a magnetic field signal rather than a signal based on an electric field and forming an eddy current generated on a metal surface by such a magnetic field, and thereafter detecting a new magnetic field signal that is secondarily generated, and is intended to present an apparatus and method for acquiring a subsurface image at a greater depth than that of a conventional scheme through a structure of equally forming the resonant frequencies of transmitting/receiving coils.

That is, in an embodiment, it is intended to generate a dominant magnetic field signal and cause a signal independent of dielectric loss to be incident on a medium such as a subsurface region, thus recognizing a subsurface object and securing a subsurface image signal. In particular, there is a characteristic that a transmission distance is extended using a method for utilizing a coil having the same resonant frequency for an object present underground.

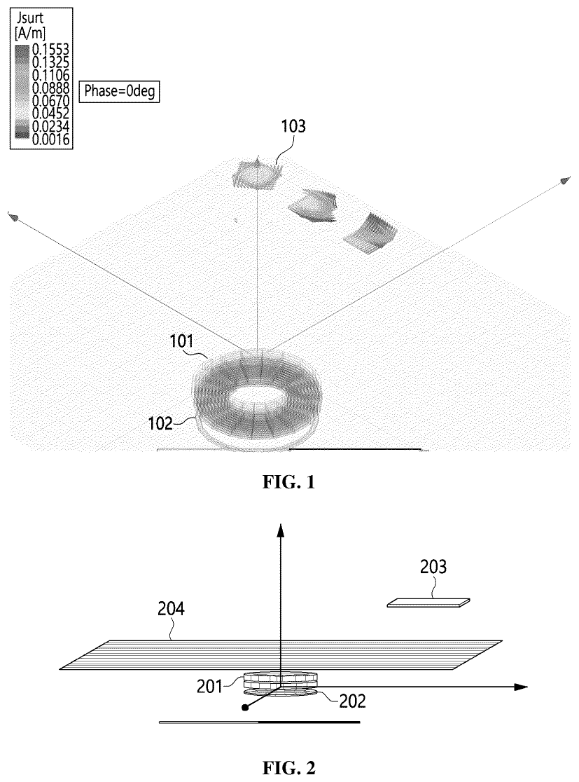

Hereinafter, a magnetic field image acquisition apparatus and method based on a resonant structure according to embodiments will be described in detail with reference to FIGS. 1 to 12. However, the sizes, numbers or thicknesses of coils used as transmitting coils in the drawings are only examples for better understanding of the present disclosure, and are not intended to restrict the present disclosure.

FIG. 1 is a diagram illustrating an example of an eddy current secondarily generated in a metal plate.

Referring to FIG. 1, as an example for generating a signal in which a magnetic field is dominant, a transmitting coil 101 for generating a magnetic field signal and a loop coil 102 for exciting the magnetic field signal are configured. Accordingly, it can be seen that, when a metal plate 103 is positioned at a certain distance from the loop coil 102, an eddy current is formed on the surface of the metal plate 103.

However, it can be confirmed that an eddy current formed on the surface of a metal plate 103-1, which is located directly above the transmitting coil 101 and corresponds to the center of the transmitting coil 101, is formed while making a ring shape.

On the other hand, it can be seen that eddy currents formed on the surfaces of metal plates 103-2 and 103-3 present at positions departing from the position, which is located directly above the transmitting coil 101 and corresponds to the center, are not formed while making a complete ring.

However, the magnitudes of the edgy currents formed on the surfaces of the metal plates 103-2 and 103-3 are greater than the magnitude of the eddy current formed on the surface of the metal plate 103-1. This means that, when a secondary magnetic field signal is generated, a signal is sufficiently generated even in the case of an edge region other than a central region.

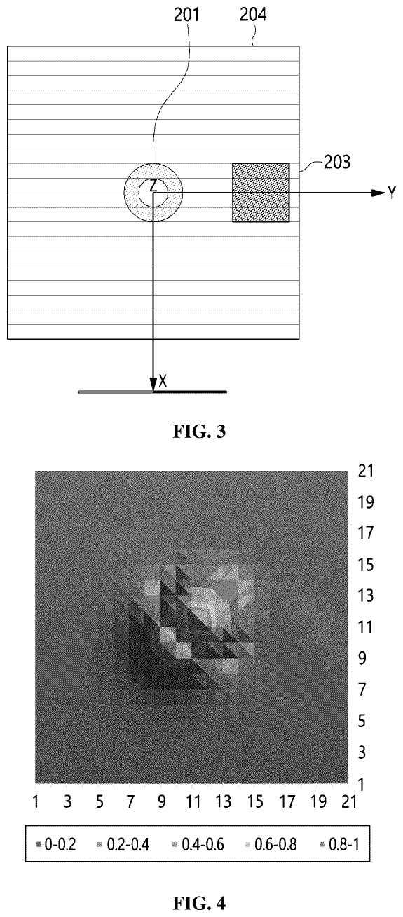

FIG. 2 is a perspective view of a system for implementing magnetic field acquisition using a metal plate, and FIG. 3 is a plan view of the system for implementing magnetic field acquisition using a metal plate.

Referring to FIGS. 2 and 3, the system for implementing magnetic field acquisition using a metal plate may be composed of a transmitting coil 201 for generating a magnetic field signal, an excitation coil 202 for feeding a signal to the transmitting coil 201, and a metal plate 203.

Here, although the system is illustrated as having an indirect feeding configuration, it may also be implemented in a direct feeding configuration by connecting an element such as a capacitor to both ends of the transmitting coil 201 to adjust a resonant frequency.

As a magnetic field is secondarily generated in a wide region 204 due to the eddy current generated in the surface of the metal plate 203, the magnetic field formed in the wide region 204 may be detected to acquire a magnetic field image of the metal plate 203.

Here, it is very important to excite the same operating frequency as the resonant frequency of the resonance coil 201.

The reason for this is that, when the operating frequency is different from the resonant frequency of the transmitting coil 201, the signal becomes significantly attenuated. Due thereto, the magnitude of the eddy current generated in the surface of the metal plate 203 decreases, and a final magnetic field signal, which is secondarily generated, also decreases, thus sharply decreasing the acquisition distance of the magnetic field image.

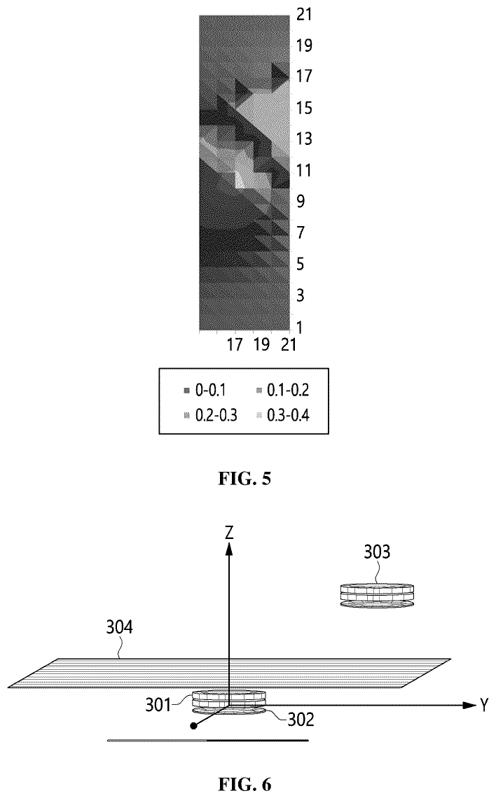

FIGS. 4 and 5 are diagrams illustrating examples of a magnetic field image acquired using a metal plate.

FIGS. 4 and 5 illustrate a magnetic field image formed by the detection of the secondary magnetic field that is generated by the eddy current generated in the metal plate illustrated in FIGS. 2 and 3.

That is, as illustrated in FIGS. 2 and 3, illustrated is the result of simulation performed on the assumption that the metal plate 203 is disposed in a portion above and to the right of the transmitting coil 201, the size of the metal plate 203 is 150×150×5 mm, and the diameter of the transmitting coil 201 is 150 mm.

The magnetic field detection region 204 in which a magnetic field is detected has an area of a width×height of 400×400 mm, and is intended to detect magnetic field signals at 21×21 points in horizontal and vertical directions, respectively.

In FIG. 4, magnetic field image signals acquired from the entire area of the magnetic field detection region 204 are illustrated. It can be seen that a large magnetic field signal is detected at a position that corresponds to 11 points in a horizontal direction and 11 points in a vertical direction and that indicates a central region in which the transmitting coil 201 is present.

In FIG. 5, a magnetic field image signal secondarily generated in a partial right portion of the magnetic field detection region is illustrated. An image obtained by extracting a region that ranges from 17 to 21 points in a horizontal direction and that is a right portion in which the metal plate 203 is present is depicted.

Here, it can be seen that, when the magnitude of the magnetic field thereof is recorded, the magnetic field has an intensity of a maximum of 0.02 A/m.

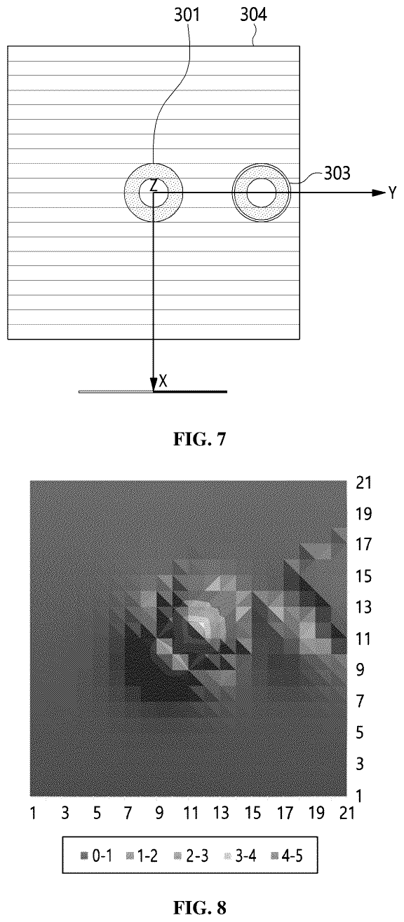

FIG. 6 is a perspective view of a system for implementing magnetic field acquisition using a resonance coil, and FIG. 7 is a plan view of the system for implementing magnetic field acquisition using a resonance coil.

Referring to FIGS. 6 and 7, it can be seen that, in the system for implementing magnetic field acquisition using a resonance coil, a resonance coil 303, instead of a metal plate 203, is arranged at the position where the metal plate 203 is arranged in FIGS. 2 and 3.

That is, although all of a transmitting coil 301, an excitation coil 302, and a detection region 304 are identical to those illustrated in FIGS. 2 and 3, the metal plate 203 is replaced with the resonance coil 303.

Here, the transmitting coil 301 does not need to match the resonance coil 303, used instead of the metal plate 203, in shape or size. However, the transmitting coil 301 and the resonance coil 303 need to be designed as coils having the same resonant frequency and the same resonance point.

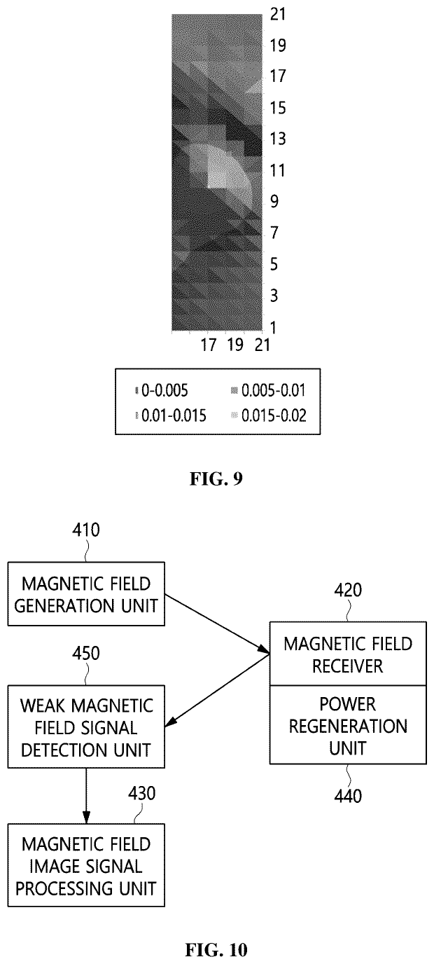

FIGS. 8 and 9 are diagrams illustrating examples of a magnetic field image acquired using a resonance coil.

FIGS. 8 and 9 illustrate magnetic field images formed by the detection of a secondary magnetic field that is generated by the resonance coil, arranged instead of the metal plate illustrated in FIGS. 6 and 7.

That is, as illustrated in FIGS. 6 and 7, illustrated are results obtained by performing simulation on the assumption that the resonance coil 303 is arranged in a portion located above and to the right of the transmitting coil 301 and that the diameter of each of the transmitting coil 301 and the resonance coil 303 is 150 mm.

Here, the magnetic field detection region 304 in which a magnetic field is detected has an area of a width×height of 400×400 mm, and is intended to detect magnetic field signals at 21×21 points in horizontal and vertical directions, respectively.

When comparing a right area where the metal plate 203 was placed in FIG. 4 with a right area where the resonance coil 303 is arranged in FIG. 8, it can be seen that the area which visible change is not large in FIG. 4 is indicated to have strong visible change in FIG. 8.

That is, although images formed at a position corresponding to 11 points in a horizontal direction and 11 points in a vertical direction are similar to each other in FIGS. 4 and 8, it can be seen that greatly different results are shown at positions corresponding to 17 points and 21 points in a horizontal direction.

In FIG. 9, a magnetic field image signal secondarily generated in a partial right portion of the magnetic field detection region is illustrated. An image obtained by extracting a region that ranges from 17 to 21 points in a horizontal direction and that is a right portion in which the resonance coil 303 is present is depicted.

When comparing the structures of FIGS. 5 and 9, it can be seen that a completely strong magnetic field signal is detected in the case where the resonance coil 303 is present compared to the case where the metal plate 203 is present.

Here, when the magnitude of the magnetic field is recorded, it can be seen that the magnetic field has an intensity of a maximum of 0.4 A/m. This shows that the magnitude is 20 times 0.02 A/m of the magnetic field detected from the metal plate 203 illustrated in FIG. 5 in terms of magnetic field signal intensity. Also, it can be confirmed that, when this value is converted in dB, the strength is improved by 25 dB. In terms of distance, there is a distance gain of about 2.71 times.

Therefore, the present disclosure proposes an apparatus and method for acquiring a magnetic field-based image using the resonance coil 303 having the same resonant frequency as the transmitting coil 301.

FIG. 10 is a schematic block configuration diagram of a magnetic field image acquisition apparatus based on a resonant structure according to an embodiment.

Referring to FIG. 10, the magnetic field image acquisition apparatus based on a resonant structure according to the embodiment may include a magnetic field generation unit 410, a magnetic field receiver 420, and a magnetic field image signal processing unit 430.

Here, the magnetic field generation unit 410 may include a circuit for dominantly generating a magnetic field and a coil structure.

According to an embodiment, as illustrated in FIGS. 6 and 7, the magnetic field generation unit 410 may include a transmitting coil 301 that generates a primary magnetic field and a resonance coil 303 that is excited by the primary magnetic field to form a secondary magnetic field.

Here, the transmitting coil 301 and the resonance coil 303 may be designed to resonate at the same operating frequency.

Also, a metal plate may be present beside the resonance coil 303.

Here, as illustrated in FIGS. 6 and 7, the magnetic field generation unit 410 may further include an excitation coil 302 that is arranged in proximity to the transmitting coil 301 to form a magnetic field for indirect feeding to the transmitting coil 301.

Here, at least one of the transmitting coil 301, the resonance coil 303, or the excitation coil 302, or a combination thereof may have a loop shape.

Here, a ferrite core may be inserted into the loop-shaped coil. Here, the ferrite core may be made of a magnetic ceramic material formed of an oxide containing iron, and may be inserted into the coil to concentrate a magnetic field and increase inductance, thus enhancing resonance efficiency. The ferrite core is characterized in that, even at a high frequency, loss is low and magnetic field leakage is reduced, thus being widely utilized in a transmitting or receiving coil in a wireless power transmission and magnetic field sensor system.

Meanwhile, the magnetic field receiver 420 may detect magnetic fields formed by the transmitting coil 301 and the resonance coil 303.

Here, the magnetic field receiver 420 may be a loop-shaped sensor array that detects magnetic fields.

Meanwhile, the magnetic field image acquisition apparatus based on a resonant structure according to an embodiment may further include a power regeneration unit 440 attached to the magnetic field receiver and configured to store a magnetic field signal and use the magnetic field signal as an energy source. That is, the power regeneration unit 440 may be utilized as an image acquisition distance and power unit to enable new various applications under the ground. For example, the power regeneration unit 440 enables proximity magnetic field communication, control, and other functions for managing subsurface facilities.

Also, the magnetic field image acquisition apparatus based on a resonant structure according to the embodiment may further include a weak magnetic field signal detection unit 450 implemented as an atomic magnetometer that detects a weak magnetic field signal with high sensitivity.

Meanwhile, the magnetic field image signal processing unit 430 may acquire a magnetic field image based on the magnitudes and phases of magnetic field signals at respective points of the magnetic field, detected by the magnetic field receiver 420, in the space.

Here, the magnetic field image signal processing unit 430 may distinguish a primary magnetic field from a secondary magnetic field.

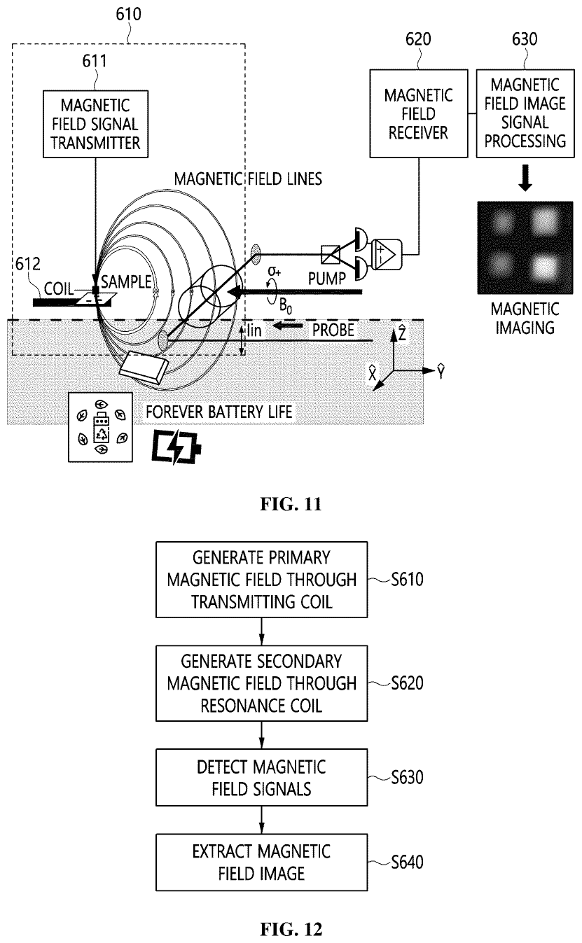

FIG. 11 is a diagram illustrating an example of the configuration of a magnetic field image acquisition apparatus based on a resonant structure according to an embodiment.

Referring to FIG. 11, a magnetic field signal transmitter 611 may be implemented as a resonance coil, as described in the above-described embodiment, or may be implemented as a non-resonance coil.

A metal plate is present underground, wherein the metal plate may exist alone, but, as in the case of the embodiment, a resonance coil 612 may also be located next to the metal plate.

As described above, as the resonance coil 612 is arranged, various advantages may be obtained as follows.

First, as described above, the resonance coil 612 increases the magnitude of the magnetic field signal detected by the magnetic field receiver 620 by strengthening a magnetic field, thus extending an image acquisition distance at which a magnetic field image can be detected.

Also, a magnetic field signal emitted from the resonance coil 612 to the magnetic field signal transmitter 610 may be stored in the power regeneration unit 440, such as that illustrated in FIG. 10, and may then be utilized as an energy source.

This assumption, when applied to an underground pipeline system, may provide higher precision compared to conventional magnetic markers, and may also transmit information to a subsurface region, thus making it useful for managing subsurface facilities.

Also, in FIG. 11, the apparatus is characterized in that the magnetic field receiver 620 is employed as an atomic magnetometer, thus enabling simultaneous measurement of the magnitude and phase of the magnetic field, and allowing extremely weak magnetic field signals to be detected. However, instead of using such an atomic magnetometer as the magnetic field receiver 620, a resonance coil may also be employed.

Also, the magnetic field image processing unit 630 may acquire image signals from the magnitudes and phases of magnetic fields obtained at respective points.

FIG. 12 is a flowchart for explaining a magnetic field image acquisition method based on a resonant structure according to an embodiment.

Referring to FIG. 12, the magnetic field image acquisition method based on a resonant structure according to the embodiment may include step S610 of generating a primary magnetic field through a transmitting coil, step S620 of generating a secondary magnetic field through a resonance coil excited by the primary magnetic field, and steps S630 and S640 of generating a magnetic field image by detecting the magnetic fields formed by the transmitting coil and the resonance coil.

Here, the transmitting coil and the resonance coil may be designed to resonate at the same operating frequency.

Here, step S610 of generating the primary magnetic field may include the step of forming a magnetic field through an excitation coil arranged in proximity to the transmitting coil and the step of generating the primary magnetic field through the transmitting coil excited by the magnetic field formed by the excitation coil.

Here, at least one of the transmitting coil, the resonance coil or the excitation coil, or a combination thereof may have a loop shape, and a ferrite core may be inserted into the loop-shaped coil.

Here, step S630 of detecting the magnetic fields may include the step of detecting a weak magnetic field signal with high sensitivity through an atom magnetometer that detects a weak magnetic field signal.

Here, steps S630 and S640 of generating the magnetic field image may include step S630 of detecting the magnetic fields generated in the space, and step S640 of acquiring a magnetic field image based on the magnitudes and phases of the magnetic field signals at respective points of the detected magnetic fields in the space.

According to embodiments, a signal based on a magnetic field rather than an electric field may be generated, thus making it more suitable for application to subsurface environments where dielectric loss is always present, and maximizing the depth at which subsurface images can be acquired.

Although the embodiment of the present disclosure has been disclosed, those skilled in the art will appreciate that the present disclosure can be implemented as other concrete forms, without departing from the scope and spirit of the disclosure as disclosed in the accompanying claims. Therefore, it should be understood that the exemplary embodiment is only for illustrative purpose and do not limit the scope of the present disclosure.

What is claimed is:

1. A magnetic field image acquisition apparatus based on a resonant structure, comprising:
a transmitting coil configured to generate a primary magnetic field; and
a resonance coil excited by the primary magnetic field to form a secondary magnetic field,
wherein the magnetic fields formed by the transmitting coil and the resonance coil are detected to generate a magnetic field image, and
wherein the transmitting coil and the resonance coil are designed to resonate at an identical operating frequency.

2. The magnetic field image acquisition apparatus of claim 1, further comprising:
an excitation coil arranged in proximity to the transmitting coil to form a magnetic field for indirect feeding to the transmitting coil.

3. The magnetic field image acquisition apparatus of claim 2, wherein at least one of the transmitting coil, the resonance coil or the excitation coil, or a combination thereof has a loop shape, and a ferrite core is inserted thereinto.

4. The magnetic field image acquisition apparatus of claim 1, further comprising:
a magnetic field receiver that is a loop-shaped sensor array configured to detect the magnetic fields.

5. The magnetic field image acquisition apparatus of claim 4, further comprising:
a power regeneration unit attached to the magnetic field receiver and configured to store the magnetic field signal and use the magnetic field signal as an energy source.

6. The magnetic field image acquisition apparatus of claim 1, further comprising:
a weak magnetic field signal detection unit implemented as an atom magnetometer that detects a weak magnetic field signal.

7. The magnetic field image acquisition apparatus of claim 4, further comprising:
a magnetic field image signal processing unit configured to acquire the magnetic field image based on magnitudes and phases of magnetic field signals at respective points of the detected magnetic fields in a space.

8. The magnetic field image acquisition apparatus of claim 7, wherein the magnetic field image signal processing unit distinguishes the primary magnetic field from the secondary magnetic field.

9. A magnetic field image acquisition method based on a resonant structure, comprising:
generating a primary magnetic field through a transmitting coil;
generating a secondary magnetic field through a resonance coil excited by the primary magnetic field; and
generating a magnetic field image by detecting the magnetic fields generated by the transmitting coil and the resonance coil,
wherein the transmitting coil and the resonance coil are designed to resonate at an identical operating frequency.

10. The magnetic field image acquisition method of claim 9, wherein generating the primary magnetic field comprises:
forming a magnetic field through an excitation coil arranged in proximity to the transmitting coil; and
generating the primary magnetic field through the transmitting coil excited by the magnetic field formed by the excitation coil.

11. The magnetic field image acquisition method of claim 10, wherein at least one of the transmitting coil, the resonance coil or the excitation coil, or a combination thereof has a loop shape, and a ferrite core is inserted thereinto.

12. The magnetic field image acquisition method of claim 9, wherein generating the magnetic field image comprises:
detecting magnetic fields generated in a space;
acquiring the magnetic field image based on magnitudes and phases of magnetic field signals at respective points of the detected magnetic fields in the space.

13. The magnetic field image acquisition method of claim 10, wherein detecting the magnetic fields comprises:
detecting a weak magnetic field signal with high sensitivity through an atom magnetometer that detects a weak magnetic field signal.

14. A magnetic field image acquisition apparatus based on a resonant structure, comprising:
a transmitting coil configured to generate a primary magnetic field;
a resonance coil excited by the primary magnetic field to form a secondary magnetic field;
a magnetic field receiver that is a loop-shaped sensor array configured to detect the magnetic fields; and
a magnetic field image signal processing unit configured to acquire a magnetic field image based on magnitudes and phases of magnetic field signals at respective points of the detected magnetic fields in a space,
wherein the transmitting coil and the resonance coil are designed to resonate at an identical operating frequency.

15. The magnetic field image acquisition apparatus of claim 14, further comprising:
an excitation coil arranged in proximity to the transmitting coil to form a magnetic field for indirect feeding to the transmitting coil.

16. The magnetic field image acquisition apparatus of claim 15, wherein at least one of the transmitting coil, the resonance coil or the excitation coil, or a combination thereof has a loop shape, and a ferrite core is inserted thereinto.

17. The magnetic field image acquisition apparatus of claim 14, further comprising:
a power regeneration unit attached to the magnetic field receiver and configured to store the magnetic field signal and use the magnetic field signal as an energy source.

18. The magnetic field image acquisition apparatus of claim 14, further comprising:
a weak magnetic field signal detection unit implemented as an atom magnetometer that detects a weak magnetic field signal.

19. The magnetic field image acquisition apparatus of claim 14, wherein the magnetic field image signal processing unit distinguishes the primary magnetic field from the secondary magnetic field.
